(19) United States
(12) Patent Application Publication
(10) Pub. No.: US 2026/0021514 A1
(43) Pub. Date: Jan. 22, 2026

(54) INDUSTRIAL VACUUM SYSTEM

(71) Applicant: Mach Energy Solutions, Inc., Midland, TX (US)

(72) Inventor: Dan Mehling, Midland, TX (US)

(73) Assignee: Mach Energy Solutions, Inc., Midland, TX (US)

(21) Appl. No.: 19/271,559

(22) Filed: Jul. 16, 2025

Related U.S. Application Data
(60) Provisional application No. 63/672,307, filed on Jul. 17, 2024.

(51) Int. Cl. B08B 5/04; B08B 3/02

(52) U.S. Cl. CPC B08B 5/04; B08B 3/024

(57) ABSTRACT

The invention relates generally to vacuum system that uses the Venturi effect to create a suction force by forcing air to travel through conduits of varying diameters. As the air travels from a conduit having a larger diameter to a conduit having a smaller diameter, the velocity of the air increases, creating a drop in pressure at the throat or choke point at which the diameter decreases. As configured, the vacuum system uses several venturi tubes that are all in fluid communication with one another to increase the amount of suction force created to move debris such as solids, liquids, sludges or combinations thereof from a first location into a container so that the debris can be removed and/or stored.

### BACKGROUND OF THE INVENTION

### 1) Field of the Invention

The present invention relates to a vacuum system that can be used to remove and store large quantities of dense and/or heavy materials such as solids, sludges and other by-products and/or waste materials resulting from mining, oil drilling, environmental decontamination and the like.

### 2) Description of Related Art

In industries where large quantities of debris and/or waste are created, whether in solid, liquid or sludge form, it is necessary to remove the debris and to store it for proper disposal. While the use of construction equipment such as bulldozers or backhoes can be used for the removal of solid waste, removal of liquids, sludges and the like becomes much more difficult.

It would be advantageous if waste could be removed by a vacuum or other device creating a sufficiently strong suction force. The suction force required to remove a combination of solids, liquids and sludges can be very large, especially when the materials to be removed are at a lower elevation than the suction device and/or storage container into which the debris is being drawn. Creating a sufficiently strong suction force can be demanding and can consume a large amount of power. Moreover, such devices often have many moving parts, the performance of which may be negatively impacted by the dirty conditions of the worksite.

It is therefore an object of the present invention to provide a vacuum system that can create suction forces sufficient to remove large volumes of solids, liquids, sludges and mixtures thereof quickly. It is an object to provide a vacuum system capable of creating suction forces in the range of −28 HG.

It is an object of the invention to provide a device that can create a suction force through the use of compressed/forced air and/or the movement of air through the system.

It is an object of the invention to provide a device that has no moving parts that may breakdown or perform poorly due to the dirty the conditions of the job site.

### SUMMARY OF THE INVENTION

In one embodiment, the present invention is a vacuum system comprising: an inlet nozzle capable of receiving a pressurized fluid; a fluid acceleration tube in fluid communication with the inlet nozzle and comprising: a first chamber that receives the pressurized fluid from the inlet nozzle, wherein the first chamber has a first interior diameter through which the pressurized fluid travels; and a second chamber that is in fluid communication with the first chamber so that the second chamber receives the pressurized fluid from the first chamber, wherein the second chamber has a second interior diameter that is less than the first diameter of the first chamber; suction inlet in fluid communication with the first chamber of the fluid acceleration tube wherein a suction force is created in the suction inlet as the pressurized fluid travels from the first chamber to the second chamber of the fluid acceleration tube and wherein the suction force draws ambient air into the suction inlet; a discharge outlet in fluid communication with the suction inlet and the fluid acceleration tube that receives the pressurized fluid from the second chamber of the fluid acceleration tube and discharges the pressurized fluid; storage container in fluid communication with the suction inlet and adapted to store materials drawn into the storage container by the suction force created so that the materials may separate from the ambient air being drawn into the storage container before the ambient air travels through the suction inlet and into the first chamber of the fluid acceleration tube; whereby when the pressurized fluid travels from the inlet nozzle to the fluid acceleration tube so that the pressurized fluid passes from the first chamber to the second chamber and out of the discharge outlet, a suction force is created in the suction inlet that causes the ambient air and the materials to enter the storage container, so the materials may be separated from the ambient air before the ambient air enters the suction inlet.

In a further embodiment of the present invention, the ambient air that enters the suction inlet travels into the first chamber, through the second chamber and into the discharge outlet so that the ambient air is discharged from the discharge outlet; the fluid acceleration tube further comprises a reducing coupling connecting the first chamber and the second chamber and that tapers from the first interior diameter of the first chamber to the second interior diameter of the second chamber.

In a further embodiment, the present invention further comprises a fluid acceleration nozzle disposed within the first chamber of the fluid acceleration chamber, wherein the fluid acceleration nozzle is in fluid communication with the inlet nozzle and comprises a first interior nozzle section having a third interior diameter that is less than the first interior diameter of the fluid acceleration chamber and a second interior nozzle section that tapers from the third interior diameter to a fourth interior diameter that is less than the third interior diameter wherein the second interior nozzle section tapers from the third interior diameter to the fourth interior diameter so that when the pressurized fluid travels through the second interior nozzle section, the pressurized fluid will be compressed and wherein the fluid acceleration nozzle further comprises a third interior nozzle section having a first end and a second end, wherein the first end is adjacent to the second interior nozzle section and has a diameter that is equal to the fourth interior diameter and the second end has a diameter equal to a fifth interior diameter, which is greater than the fourth interior diameter so that the third interior nozzle section widens from the fourth interior diameter to the fifth internal diameter so that when the pressurized fluid travels through the third interior nozzle section, the pressurized fluid expands.

In a further embodiment, the second chamber of fluid acceleration tube has a first end and a second end, wherein the first end is adjacent to the fluid acceleration nozzle and the second end is adjacent to the discharge outlet and wherein the first end has a sixth diameter and the second end has an seventh diameter that is greater than the sixth diameter so that the pressurized fluid traveling through the sixth diameter will expand.

In another embodiment the present invention is a vacuum system comprising: an inlet nozzle capable of receiving a compressed fluid; a venturi tube (fluid acceleration tube) in fluid communication with the inlet nozzle and comprising: a fluid intake that receives the compressed fluid from the inlet nozzle; a first chamber that receives the compressed fluid from the fluid intake, wherein the first chamber has a first diameter through which the compressed fluid may flow; and a second chamber that is connected to the first chamber so that the second chamber receives the compressed fluid from the first chamber, wherein the second chamber has a second diameter that is less than the first diameter of the first chamber. The vacuum system further includes a discharge tube that is connected to the second chamber and receives the compressed fluid from the second chamber and discharges the fluid; a suction tube connected to and in fluid communication with the first chamber wherein the suction tube creates a suction force that draws in ambient air as the compressed gas travels from the first chamber to the second chamber; a vacuum box in fluid communication with the suction tube and adapted to store materials drawn into the vacuum box by the suction force created by the suction tube so that the materials may separate from the ambient air being drawn into the vacuum box before the ambient air travels through the suction tube into the first chamber of the venturi tube; and, whereby when the compressed air travels from the inlet nozzle to the venturi tube so that the compressed air passes from the first chamber to the second chamber and out of the discharge tube, the suction tube creates a suction force that pulls the ambient air and materials into the vacuum box, so the materials are separated from the ambient air before the ambient air enters the suction tube.

In at least one embodiment, the vacuum system further includes a manifold interconnecting the inlet nozzle and the venturi tube so as to place the inlet nozzle in fluid communication with the venturi tube.

In at least one embodiment, the venturi tube further includes a reducing coupling connecting the first chamber and the second chamber and the fluid intake has a third diameter that is less than the first diameter of the first chamber.

In at least one embodiment, the vacuum system includes two venturi tubes interconnected by a suction tube having a T-junction. In another embodiment, the vacuum system includes four venturi tubes interconnected by the suction tube that is in fluid communication with the first chamber of each venturi tube so that as ambient air is drawn into the suction tube the ambient air is capable of traveling to each venturi tube.

In at least one embodiment, the vacuum box includes an inlet valve and an outlet valve, a suction hose that is connected to the inlet valve and a connection conduit that is connected to the outlet valve and interconnects the vacuum box to the suction tube. In at least one embodiment, the inlet valve and the outlet valve of the vacuum box are vertically spaced from a floor of the vacuum box so that materials drawn into the vacuum box through the suction hose fall to the floor while the ambient air travels through the outlet valve and to the suction tube.

### BRIEF DESCRIPTION OF THE DRAWINGS

The construction designed to carry out the invention will hereinafter be described, together with other features thereof. The invention will be more readily understood from a reading of the following specification and by reference to the accompanying drawings forming a part thereof, wherein an example of the invention is shown and wherein:

FIG. 1 shows perspective view of an embodiment of the invention;

FIG. 2 shows a perspective view of the internal components of an embodiment of the invention;

FIG. 3 illustrates a side elevation view of a nozzle that is located within the internal components of an embodiment of the invention;

FIG. 4 shows a top plan view of the nozzle used in an embodiment of the present invention

FIG. 5 shows a front elevation view of the internal components of an embodiment of the invention;

FIG. 6 illustrates a side elevation view of the internal components of an embodiment of the invention; and

FIGS. 7-9—show an embodiment of the present invention in use.

It will be understood by those skilled in the art that one or more aspects of this invention can meet certain objectives, while one or more other aspects can meet certain other objectives. Each objective may not apply equally, in all its respects, to every aspect of this invention. As such, the preceding objects can be viewed in the alternative with respect to any one aspect of this invention. These and other objects and features of the invention will become more fully apparent when the following detailed description is read in conjunction with the accompanying figures and examples. However, it is to be understood that both the foregoing summary of the invention and the following detailed description are of a preferred embodiment and not restrictive of the invention or other alternate embodiments of the invention. In particular, while the invention is described herein with reference to a number of specific embodiments, it will be appreciated that the description is illustrative of the invention and is not constructed as limiting of the invention. Various modifications and applications may occur to those who are skilled in the art, without departing from the spirit and the scope of the invention, as described by the appended claims. Likewise, other objects, features, benefits and advantages of the present invention will be apparent from this summary and certain embodiments described below, and will be readily apparent to those skilled in the art. Such objects, features, benefits and advantages will be apparent from the above in conjunction with the accompanying examples, data, figures and all reasonable inferences to be drawn therefrom, alone or with consideration of the references incorporated herein.

### DETAILED DESCRIPTION OF A PREFERRED EMBODIMENT

With reference to the drawings, the invention will now be described in more detail. The present invention uses the Venturi effect to create a vacuum by forcing a fluid, such as air, to travel through conduits of varying diameters. As the air travels from a conduit having a larger diameter to a conduit having a smaller diameter, the velocity of the air increases, creating a drop in pressure at the throat or choke point at which the diameter decreases. As configured, the vacuum system uses that drop in pressure to create a suction force that may move debris such as solids, liquids, sludges or combinations thereof from a first location and into a container so that the debris can be removed and/or stored. The vacuum is adapted to accommodate and/or create air flows having a very high velocity. As the velocity of the air flow is increased, the drop in pressure and thus the resulting suction force also increases.

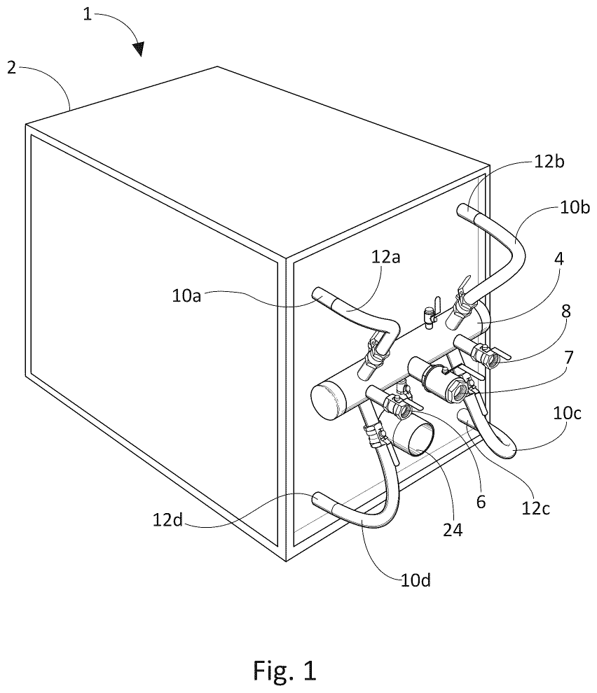

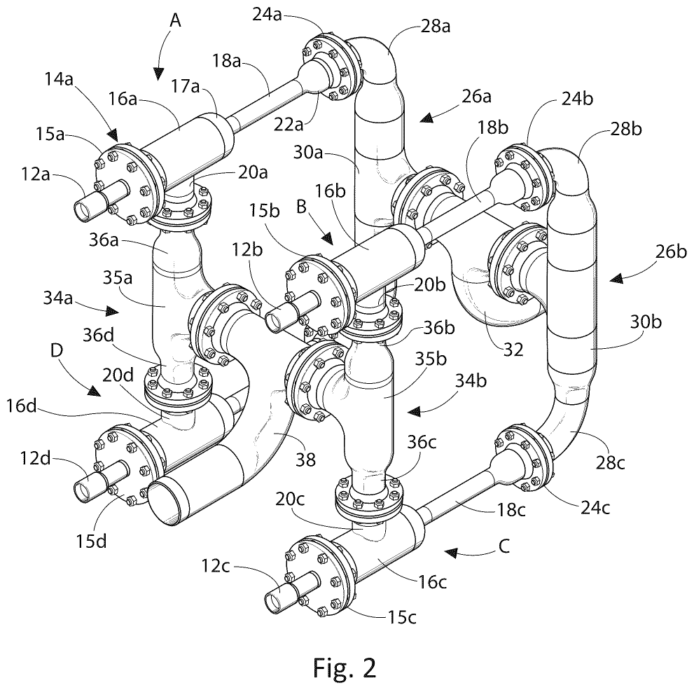

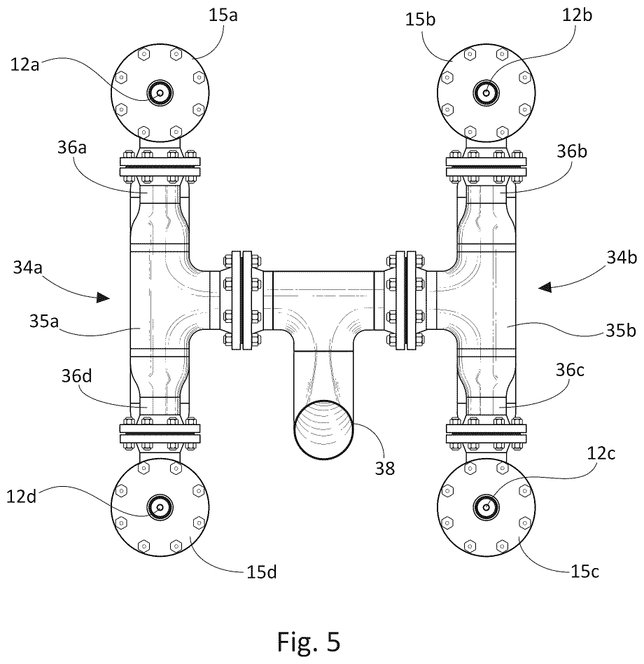

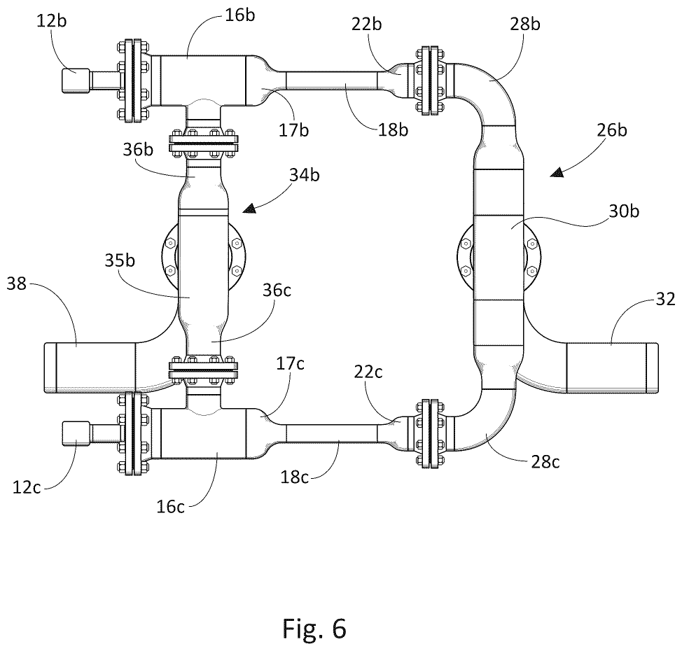

Referring now to FIGS. 1-6, an embodiment of the present invention is described herein. As shown in FIG. 1, the vacuum system, which is generally shown as 1, includes a housing 2 that houses the internal components shown in FIGS. 2-6. The present invention may further include an air header 4 having three inlet nozzles 6-8 that may be connected to an air compressor (not shown) or other source of forced gas. While any fluid could work, gas and more specifically air is preferred due to its economical, abundant and environmentally safe nature. As forced air enters the air header 4, it is distributed to at least one (but preferably all) of the four high-pressure hoses 10a-d interconnecting the air header 4 to the four motive gas supply inlets 12a-d.

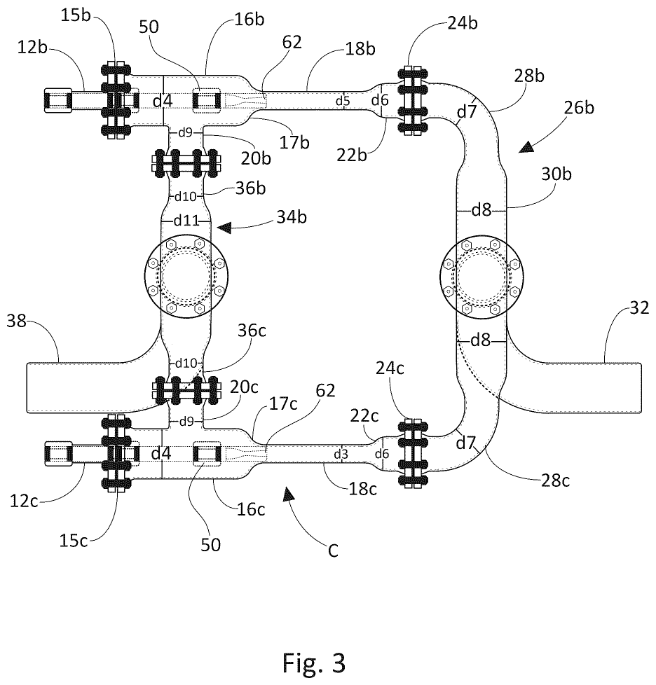

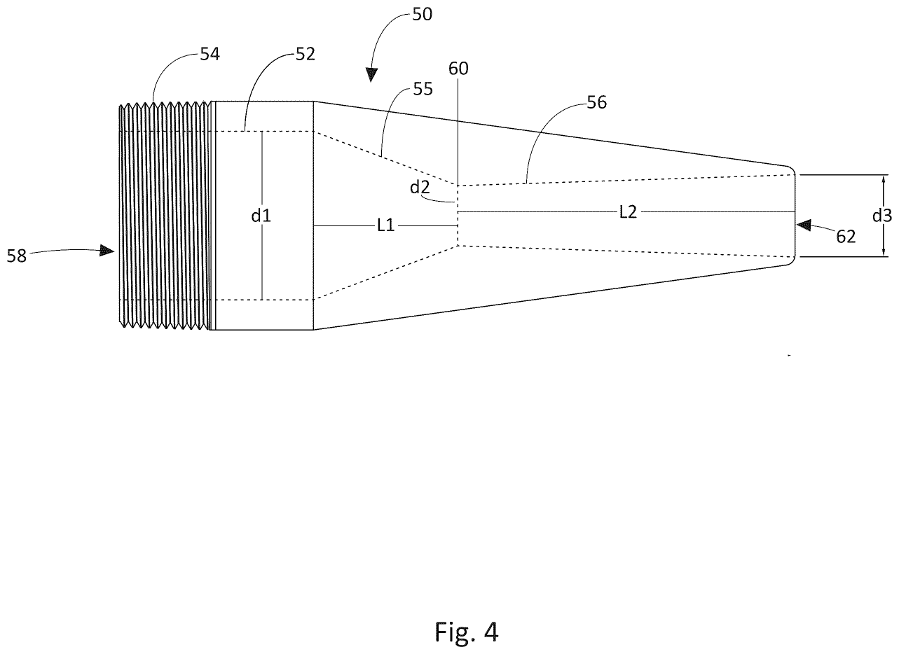

A venturi nozzle assembly 14a-d interconnects the gas supply inlets 12a-d to a first suction chamber 16a-d of the venturi tubes (generally shown as A-D). The venturi nozzle assembly 14a-d comprises an inlet flange 15a-d that houses a venturi nozzle shown as 50 in FIGS. 3-4. The venturi nozzle (also referred to as a fluid acceleration nozzle) 50 includes a first section 52 that is generally cylindrical and has a first inner diameter d1. The first interior nozzle section 52 may include external threading 54 on its exterior surface so that the venturi nozzle 50 may be secured to the corresponding gas supply inlet 12b. The fluid acceleration nozzle 50 also includes a second interior section 55 that has a diameter that narrows and/or tapers from d1 down to d2 along a first length L1 extending from the widest end of the nozzle's second interior section 56 to the nozzle choke point 60. The fluid acceleration nozzle 50 further includes a third internal section 56 that has an internal diameter that widens and/or increases from d2 up to d3 along a second length L2 extending from the nozzle choke point to the nozzle outlet 62. In one embodiment d1 is equal to 1.63 inches while d2 equals 0.63 inches and d3 equals 0.85 inches. These diameters are meant to create the pressures created by the moving air such that will propel the air flow forward through the venturi nozzle 50 and into the first chamber 16a-d. As air enters the nozzle inlet 58 and travels towards the nozzle choke point 60, the air becomes compressed, thus increasing its velocity and creating an area of low pressure at the choke point, which helps to draw the air towards the choke point. As the air travels towards the nozzle outlet 62, the air is allowed to expand slightly, thus creating a point of high pressure at the nozzle outlet which helps to propel the air out from the nozzle outlet 62.

Each of the venturi tubes (A-D in FIG. 2), which are also referred to as fluid acceleration tubes, has a first suction chamber 16a-d having a first diameter d4 and a second diffuser chamber 18a-d having a second diameter d5 that is less than the first diameter of the first suction chamber 16a-d. In one embodiment, the first chamber 16a-d is connected to the second chamber 18a-d by a reducing coupler 17a-d. In other embodiments, the first chamber 16a-d is integrally connected to the second chamber 18a-d. As can be seen in FIG. 3, the venturi nozzle 50 extends from the gas supply inlet 12b and/or the inlet flange 15b into the first suction chamber 16b. In the embodiment shown in FIG. 3, the venturi nozzle outlet 62 extends to a point that is immediately adjacent to the narrow end of the reducing coupler 17b that interconnects the venturi tube's first chamber 16b to the second chamber 18b. As the air leaves the venturi nozzle outlet, it passes into the first chamber 16b, through the reducing coupler 17b and into the second chamber 18b. As it does so, the air becomes compressed, and its velocity increases thus creating a low pressure point at the reducing coupler 17b (or if the first chamber 16b and the second chamber are integrally connected, the reducing coupler would be replaced with a chamber choke point that serves the same purpose).

Once the air enters the second chamber 18b, it travels towards an outlet flange 24b, where it exits into a discharge header 26b. In one embodiment, the second chamber 18b includes an expansion coupler 22b that flares out to a diameter d6 that is greater than the diameter d5 of the second chamber 18b. In another embodiment, the expansion coupler could be replaced with a flared section that is integrally connected to the second chamber and provides diameter d6. This expansion coupler and/or flared section creates a high pressure point that helps propel the gas towards the discharge header 26b.

In the shown embodiment, the discharge headers 26a-b include a narrow section 28a-d that is connected to the discharge flange 24a-d and has a diameter d7 and a wide section 30a-b having a diameter d8. Diameter d8 is greater than diameter d7, where diameter d7 is approximately equal to diameter d6. This increased diameter d8 helps to accommodate the air being discharged from four venturi tubes and decreases the amount of back pressure that may inhibit or otherwise slow the flow of air out of the venturi tube's second chamber 18a-d. As the air enters the discharge header 26a-b, it evacuates from the system through discharge header outlet 32. In the shown embodiment, the vacuum system includes four separate venturi tubes A-D that are placed in a generally square or rectangular configuration where venturi tubes A & B are laterally spaced from one another, venturi tubes C & D are laterally spaced from one another while venturi tubes A & D are vertically spaced from one another, and venturi tubes B & C are similarly vertically spaced. In this arrangement, the discharge header outlet 32 interconnects discharge headers 26a-b so that all the air flowing from each of the venturi tubes A-D exits the system through discharge header outlet 32.

The first chamber 16a-d of the venturi tube A-D further includes a venturi tube suction inlet 20a-d that is connected to a suction header 34a-b which is in turn connected to a suction header inlet 38. As the pressurized fluid (such as compressed air) from the air header (shown as 4 in FIG. 1) enters the venturi tube A-D through the gas supply inlet 12a-d, it passes through the venturi nozzle 50 and into the first chamber 16a-d. As the pressurized air moves from the first chamber 16a-d into the second chamber 18a-d, it becomes compressed by the reducing coupler and/or chamber choke point 17a-d. As a result, the velocity of the air increases and the pressure at the coupler/choke point 17a-d drops which draws ambient air into the suction header inlet 38, where the ambient air then passes through the suction header 34a-b, then passes through the venturi tube suction inlet 20a-d and into the first suction chamber 16a-d of the venturi tube A-D. The low pressure created at the coupler/choke point 17a-d draws the ambient air around the fluid acceleration nozzle and into the second chamber 18a-d where it continues to travel to the discharge header 26a-b where both the ambient air and the pressurized fluid are discharged and/or exit out of the discharge header outlet 38.

In the shown embodiment, each suction header 34a-b includes at least one but preferably two narrow sections 36a-b that is connected to the venturi tube suction inlet 20a-d and has a diameter d10 that is approximately equal to the diameter d9 of the venturi tube suction inlet 20a-d. The suction header 34a-b further includes a wide section 35a-b having a diameter d11 that is greater than diameter d10. Thus, when air flows from the suction header into the venturi suction inlet 20a-d, its velocity increases, which helps the vacuum system operate smoothly while creating greater suction forces. In the shown embodiment where the venturi tubes A-D are in a generally square or rectangular arrangement, the suction header inlet 38 interconnects the two suction headers 34a-b so that the ambient air drawn in from the suction header inlet 38 travels through each suction header 34a-b and into each of the venturi tubes A-D. In the shown embodiment, the suction header inlet 38 forms a T-junction that interconnects the suction headers

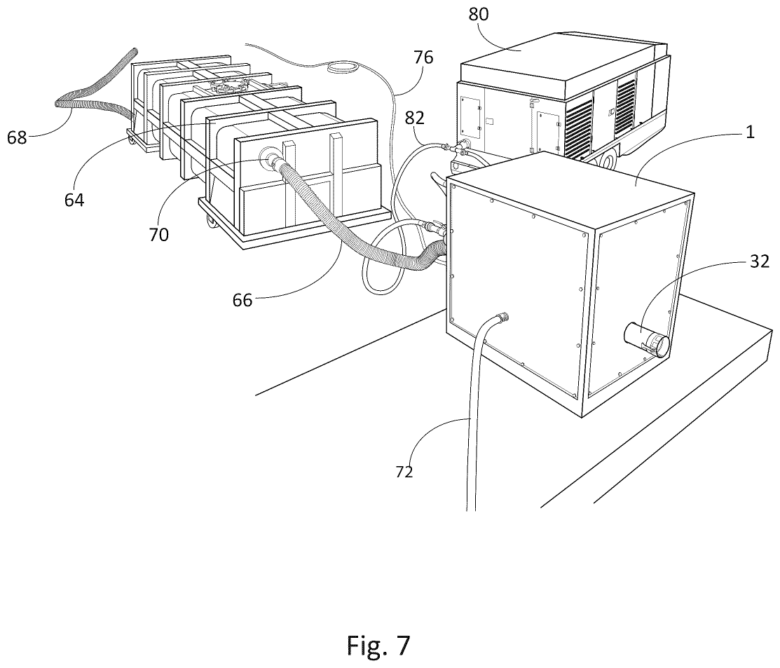

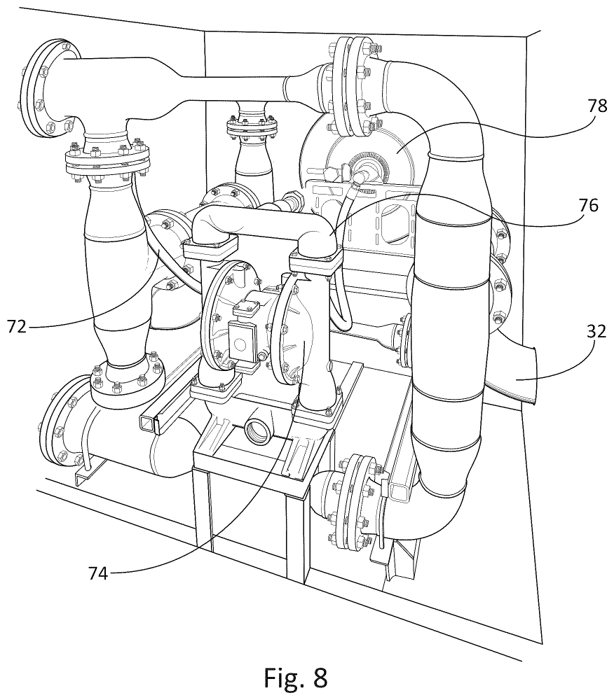

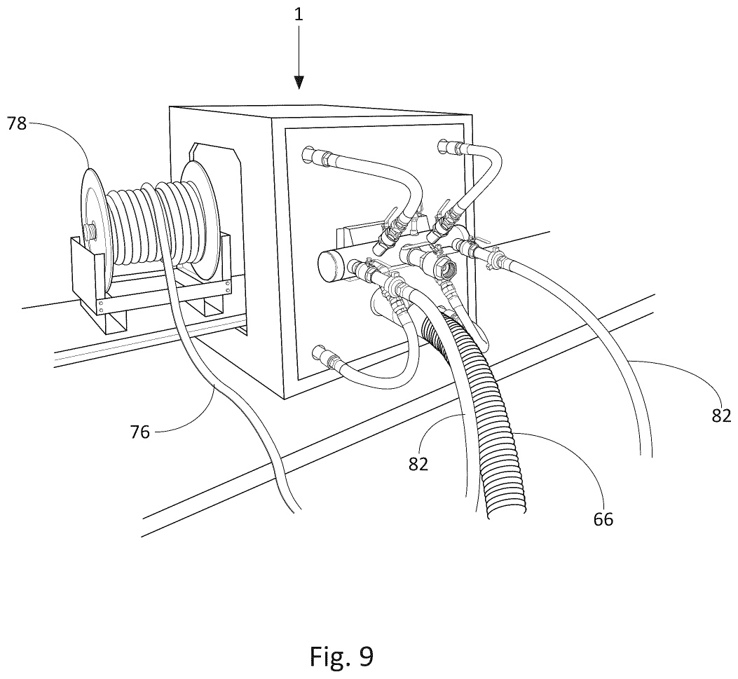

Referring now to FIGS. 7-9, a further embodiment of the present invention can be seen. In this embodiment, the vacuum system 1 may be connected to a first side of a storage container (at times referred to as a vacuum box) 64 by way of an extension conduit 66, which may be flexible or rigid. The storage container 64 may further include a suction hose 68 that is connected to a second side of the vacuum box, which is preferably opposite of the first side to which the extension conduit 66 is connected. This suction hose can be placed near or in the debris to be removed and/or stored. The suction force created by the vacuum system will draw ambient air into the suction hose 68 along with the debris.

In at least one embodiment both the suction hose 68 and the extension conduit 66 are connected at a point 70 on the vacuum box's sidewalls that is vertically spaced from the floor of the vacuum box. This allows the ambient air to separate from the debris drawn in to the vacuum box as the debris settles to the floor of the vacuum box 64. This placement of the suction hose and extension conduit also maximizes the amount of debris that may be stored in the vacuum box.

In another embodiment, the vacuum system 1 may further include a water supply line 72 that is connected to a hydraulic pump 74 that pumps the water through a water discharge hose 76 which may be connected to a hose reel 78 that can store a long length of the discharge hose. This discharge hose 76 may be connected to the suction hose 68 so that water from the discharge hose 76 may direct debris towards the suction hose 68.

In use, a pressurized fluid, such as pressurized or compressed gases (e.g., compressed air) may be forced into the air header inlets 6-7, where the air travels from the air header 4 into the high pressure lines 10a-d and into the motive gas inlets 12a-d. From there, the compressed air travels through the venturi nozzle, where the velocity of the air flow increases before it goes in the first venturi suction chamber 16a-d, through the reducing coupler/chamber choke point 17a-d and into the second diffuser chamber. The air flow continues to flow into the discharge headers 26a-b and out of the discharge header outlet 38. As a result of this air flow, each of the venturi tubes A-D creates a suction force that causes ambient air to be drawn into the suction header inlet 38. From there, the ambient air travels through the suction header and into the first suction chamber 18a-d by way of the suction chamber inlet 20a-d. This ambient air combines with the flow of compressed air until it is discharged through the discharge outlet 32.

The air flow moving through the venturi tubes A-D may achieve speeds of 343 m/s or greater, which can create suction forces upwards of −28 HG. Because there are no moving parts the primary limitation as to the amount of suction force that can be created is the velocity at which air may be forced into the air header inlet nozzles 6-8. Typically, an air compressor 80 is connected to one or more of the air header inlet nozzles 6-7 by way of a high-pressure line 82 and is used to force the air into the air header inlet nozzles.

While a preferred embodiment of the invention has been described using specific terms, such description is for illustrative purposes only, and it is to be understood that changes and variations may be made without departing from the spirit or scope of the following claims.

What is claimed is:

1. A vacuum system comprising:
An inlet nozzle capable of receiving a pressurized fluid;
A fluid acceleration tube in fluid communication with the inlet nozzle and comprising:
A first chamber that receives the pressurized fluid from the inlet nozzle, wherein the first chamber has a first interior diameter through which the pressurized fluid travels; and
A second chamber that is in fluid communication with the first chamber so that the second chamber receives the pressurized fluid from the first chamber, wherein the second chamber has a second interior diameter that is less than the first diameter of the first chamber;
A suction inlet in fluid communication with the first chamber of the fluid acceleration tube wherein a suction force is created in the suction inlet as the pressurized fluid travels from the first chamber to the second chamber of the fluid acceleration tube and wherein the suction force draws ambient air into the suction inlet;
A discharge outlet in fluid communication with the suction inlet and the fluid acceleration tube that receives the pressurized fluid from the second chamber of the fluid acceleration tube and discharges the pressurized fluid;
A storage container in fluid communication with the suction inlet and adapted to store materials drawn into the storage container by the suction force created so that the materials may separate from the ambient air being drawn into the storage container before the ambient air travels through the suction inlet and into the first chamber of the fluid acceleration tube; and,
Whereby when the pressurized fluid travels from the inlet nozzle to the fluid acceleration tube so that the pressurized fluid passes from the first chamber to the second chamber and out of the discharge outlet, a suction force is created in the suction inlet that causes the ambient air and the materials to enter the storage container, so the materials may be separated from the ambient air before the ambient air enters the suction inlet.

2. The system of claim 1 wherein the ambient air that enters the suction inlet travels into the first chamber, through the second chamber and into the discharge outlet so that the ambient air is discharged from the discharge outlet.

3. The system of claim 1 wherein the fluid acceleration tube further comprises a reducing coupling connecting the first chamber and the second chamber and that tapers from the first interior diameter of the first chamber to the second interior diameter of the second chamber.

4. The system of claim 1 further comprising a fluid acceleration nozzle disposed within the first chamber of the fluid acceleration chamber, wherein the fluid acceleration nozzle is in fluid communication with the inlet nozzle and comprises a first interior nozzle section having a third interior diameter that is less than the first interior diameter of the fluid acceleration chamber and a second interior nozzle section that tapers from the third interior diameter to a fourth interior diameter that is less than the third interior diameter.

5. The system of claim 4 wherein the second interior nozzle section tapers from the third interior diameter to the fourth interior diameter so that when the pressurized fluid travels through the second interior nozzle section, the pressurized fluid will be compressed.

6. The system of claim 4 wherein the fluid acceleration nozzle further comprises a third interior nozzle section having a first end and a second end, wherein the first end is adjacent to the second interior nozzle section and has a diameter that is equal to the fourth interior diameter and the second end has a diameter equal to a fifth interior diameter, which is greater than the fourth interior diameter.

7. The system of claim 6 wherein the third interior nozzle section widens from the fourth interior diameter to the fifth internal diameter so that when the pressurized fluid travels through the third interior nozzle section, the pressurized fluid expands.

8. The system of claim 1 further comprising a fluid acceleration nozzle disposed within the first chamber of the fluid acceleration chamber, wherein the fluid acceleration nozzle is in fluid communication with the inlet nozzle and includes a third, fourth and fifth internal diameter wherein the fourth internal diameter is less than the third internal diameter and the fifth internal diameter is greater than the fourth internal diameter so that the fourth internal diameter compresses the pressurized fluid traveling through the fourth internal diameter and so that the fifth internal diameter allows the pressurized fluid to expand when traveling through the fifth internal diameter.

9. The system of claim 1 wherein second chamber of fluid acceleration tube has a first end and a second end, wherein the first end is adjacent to the fluid acceleration nozzle and the second end is adjacent to the discharge outlet and wherein the first end has a sixth diameter and the second end has an seventh diameter that is greater than the sixth diameter so that the pressurized fluid traveling through the sixth diameter will expand.

10. A vacuum system comprising:
A fluid acceleration tube capable of receiving a pressurized fluid and comprising:
A first chamber that receives the pressurized fluid, wherein the first chamber has a first interior diameter through which the pressurized fluid travels; and,
A second chamber that is in fluid communication with the first chamber so that the second chamber receives the pressurized fluid from the first chamber, wherein the second chamber has a second interior diameter that is less than the first interior diameter of the first chamber;
a fluid acceleration nozzle disposed within the first chamber of the fluid acceleration tube comprising:
a first interior nozzle section that receives the pressurized fluid entering the first chamber and having a third interior diameter that is less than the first interior diameter of the fluid acceleration tube,
a second interior nozzle section that is in fluid communication with the first interior nozzle section and having a fourth interior diameter that is less than the third interior diameter so that the pressurized fluid traveling from the first interior nozzle section is compressed by the fourth interior diameter; and
a third interior nozzle section having a fifth interior diameter that is greater than the fourth interior diameter so that the pressurized fluid traveling from the second interior nozzle section is allowed to expand;
A suction inlet in fluid communication with the first chamber of the fluid acceleration tube wherein a suction force is created in the suction inlet as the pressurized fluid travels from the fluid acceleration nozzle to the second chamber of the fluid acceleration tube and wherein the suction force draws ambient air into the suction inlet;
A discharge outlet in fluid communication with the suction inlet and the fluid acceleration tube that receives the pressurized fluid from the second chamber of the fluid acceleration tube and discharges the pressurized fluid; and,
Whereby when the pressurized fluid travels from the fluid acceleration nozzle into the section chamber of the fluid acceleration tube, a suction force is created in the suction inlet.

11. The system of claim 8 wherein the discharge outlet further receives from the second chamber of the fluid acceleration tube the ambient air that travels from the suction inlet into the fluid acceleration tube.

12. The system of claim 9 further comprising a storage container in fluid communication with the suction inlet and adapted to store materials drawn into the storage container by the suction force created so that the materials may separate from the ambient air being drawn into the storage container before the ambient air travels through the suction inlet into the first chamber of the fluid acceleration tube.

13. The system of claim 12 further comprising a conduit interconnecting the suction inlet to a first side of the storage container and a suction hose connected to a second side of the storage container so that the suction hose, the storage container and the conduit are in fluid communication with the suction inlet.

14. The system of claim 9 wherein the second interior nozzle section of the fluid acceleration nozzle tapers from the third interior diameter to the fourth interior diameter so that when the pressurized fluid travels through the second interior nozzle section, the pressurized fluid will be compressed and wherein the third interior nozzle section widens from the fourth interior diameter to the fifth internal diameter so that when the pressurized fluid travels through the third interior nozzle section, the pressurized fluid expands.

15. The system of claim 9 wherein second chamber of fluid acceleration tube has a first end and a second end, wherein the first end is adjacent to the first chamber and the second end is adjacent to the discharge outlet and wherein the first end has a sixth diameter and the second end has an seventh diameter that is greater than the sixth diameter so that the pressurized fluid traveling through the second end will expand.

16. A vacuum system comprising:
A fluid acceleration tube in fluid communication capable of receiving a pressurized fluid and comprising:
A first chamber that receives the pressurized fluid, wherein the first chamber has a first interior diameter through which the pressurized fluid travels; and,
A second chamber that is in fluid communication with the first chamber so that the second chamber receives the pressurized fluid from the first chamber, wherein the second chamber has a second interior diameter that is less than the first interior diameter of the first chamber;
a fluid acceleration nozzle disposed within the first chamber of the fluid acceleration tube comprising:
a first interior nozzle section that receives the pressurized fluid entering the first chamber of the fluid acceleration tube and having a third interior diameter that is less than the first interior diameter of the first chamber, and
a second interior nozzle section that is in fluid communication with the first interior nozzle section and having a fourth interior diameter that is less than the third interior diameter so that the pressurized fluid traveling from the first interior nozzle section is compressed by the fourth interior diameter;
A suction inlet in fluid communication with the first chamber of the fluid acceleration tube wherein a suction force is created in the suction inlet as the pressurized fluid travels from the fluid acceleration nozzle to the second chamber of the fluid acceleration tube and wherein the suction force draws ambient air into the suction inlet.

17. The system of claim 16 wherein the fluid acceleration nozzle further comprises a third interior nozzle section having a first end that is adjacent to the second interior nozzle section and a second end from which the pressurized fluid exits the fluid acceleration nozzle, wherein the second end has a fifth interior diameter that is greater than the fourth interior diameter of the second interior nozzle section so that the pressurized fluid traveling through the third interior nozzle section will expand.

18. The system of claim 16 wherein the first end of the third interior nozzle section is laterally spaced from the second end of the third interior nozzle section by a first length and wherein the third interior nozzle section widens from the fourth interior diameter to the fifth interior diameter along the first length.

19. The system of claim 16 further comprising a discharge outlet in fluid communication with the suction inlet and the fluid acceleration tube and that receives the pressurized fluid from the second chamber of the fluid acceleration tube and further receives from the second chamber of the fluid acceleration tube the ambient air that travels from the suction inlet into the fluid acceleration tube and wherein the discharge outlet discharges both the pressurized fluid and the ambient air received from the second chamber.

20. The system of claim 16 further comprising a storage container in fluid communication with the suction inlet and adapted to store materials drawn into the storage container by the suction force created so that the materials may separate from the ambient air being drawn into the storage container before the ambient air travels through the suction inlet into the first chamber of the fluid acceleration tube.
